(19) United States
(12) Patent Application Publication
(10) Pub. No.: US 2017/0062827 A1
(43) Pub. Date: Mar. 2, 2017

(54) POLYMER COMPOSITIONS AS A BINDER SYSTEM FOR LITHIUM-ION BATTERIES

(71) Applicant: Wacker Chemie AG, Muenchen (DE)

(72) Inventors: Christian BRUCKMEIER, Muenchen (DE); Stefan HAUFE, Neubiberg (DE); Felicitas SCHAUER, Muenchen (DE)

(21) Appl. No.: 15/119,946

(22) PCT Filed: Feb. 24, 2015
(86) PCT No.: PCT/EP2015/053846

§ 371 Date: Aug. 18, 2016

(30) Foreign Application Priority Data
Feb. 28, 2014 (DE) 10 2014 203 750.6

(51) Int. Cl. H01M 4/62; H01M 4/134; H01M 4/38; C08L 29/04; H01M 4/1395; H01M 4/04; C08L 23/08; H01M 10/0525; H01M 4/66

(52) U.S. Cl. CPC H01M 4/622; H01M 10/0525; H01M 4/134; H01M 4/386; H01M 4/625; H01M 4/661; H01M 4/1395; H01M 4/0404; C08L 23/0861; C08L 29/04; H01M 2004/027

(57) ABSTRACT

The invention relates to a polymer composition P containing: 100 parts-by-weight of polymer 1, which polymer is at least 50 g/l water-soluble at 25° C. and 1 bar, and can be produced via radical-initiated polymerisation of more than 95 wt. % of monomers from the group of acrylic acid, methylacrilic acid, or the esters thereof, acrylonitrile and vinylester, and, optionally, via subsequent alkaline hydrolysis; 10 to 200 parts-by-weight of polymer 2, which polymer is at least 10 g/l water-soluble at 25° C. and 1 bar, has a viscosity of a 1 wt. % aqueous solution at 25° C. and 1 bar at a shear rate of 10/s>1.0 Pas, and at a shear rate of 120/s<0.7 Pas, from the group of polysaccharides, celluloses or the carboxymethyl-, methyl-, hydroxyethyl- or hydroxypropyl derivatives thereof; and 20 to 300 parts-by-weight of polymer 3, which polymer is at least 10 g/l water-soluble at 25° C. and 1 bar, and can be produced via radical-initiated polymerisation of more than 30-95 wt. % of monomer A, from monomers from the group of acrylates or vinyl acetates, and 5-70 wt. % of monomer B of general formula R—CH═CH₂, wherein R represents hydrogen, methyl, ethyl, propyl, isopropyl, phenyl or o-tolyl, and optionally, via subsequent alkaline hydrolysis. The invention also relates to: an electrode coating for a lithium-ion battery, containing the polymer composition P; a lithium-ion battery containing the polymer composition P; and the use of the polymer composition P as a binder system for the anode of a lithium-ion battery.

The invention relates to a polymer composition P composed of three polymers, to an electrode coating for a lithium ion battery comprising the polymer composition P, to a lithium ion battery comprising the polymer composition P, and to the use of the polymer composition P as binder system for the anode of a lithium ion battery.

Because of their high energy densities, lithium ion batteries are among the most promising energy storage means for mobile applications. The fields of use range from high-value electronic devices as far as batteries for electrically driven motor vehicles and stationary power storage means.

The development of higher-performance anode materials for Li ion batteries is simultaneously requiring the development of compatible binder systems. PVDF, which is used for graphite electrodes, is unsuitable for use in silicon-containing electrodes owing to chemical and mechanical instability. This is manifested in poor electrochemical cycling characteristics. In order to cope with the extreme change in volume (up to about 300%) experienced by the silicon on lithiation/delithiation and the associated mechanical stress, alternatives that have been described aqueously processible binder systems, for example sodium carboxymethylcellulose (Na-CMC), polyvinyl alcohols, acrylates or else mixtures of Na-CMC with styrene-butadiene rubbers.

Standard binder systems frequently lead to inhomogeneous coatings (see, for example, US2007/0264568) and have a high loss of capacity over the charge and discharge cycles, especially at high areal loadings. More particularly, during the charge and discharge cycles, a high irreversible loss of lithium occurs.

In anodes for lithium ion batteries in which the active electrode material is based on silicon as the material having the highest known storage capacity for lithium ions, the silicon in the course of charging or discharging with lithium experiences an extreme change in volume by about 300%. This change in volume results in significant mechanical stress on the entire electrode structure, which leads to loss of electrical contact of the active material and hence to destruction of the electrode with loss of capacity. Furthermore, the surface of the silicon anode material used reacts with constituents of the electrolyte with continuous, irreversible loss of lithium, forming or reforming passive protective layers (solid electrolyte interfaces; SEIs).

In order to solve these problems which are known specifically for Si-based anodes, various approaches have been pursued in the last few years for electrochemical stabilization of Si-based active electrode materials (A. J. Appleby et al., J. Power Sources 2007, 163, 1003-1039).

An important function is assumed here by the binder: PVdF as standard binder, as employed in conventional graphite anodes, is inadequate in the case of silicon-containing anodes. Because of its high concentration of hydroxyl groups and the associated good binding to the active materials, polyvinyl alcohol (PVA) is an obvious binder, as described, for example, in U.S. Pat. No. 5,707,759. Problems in the case of Si-based anodes with this PVA binder are described in US2007/0264568, especially an excessively low viscosity which leads to inhomogeneous coating of the metal foil that serves as current collector, and a high irreversible loss of lithium or high irreversible loss of capacity. The use of high molecular weight polyvinyl alcohol (Pn>2500) with a hydrolysis level of >90% is proposed, this leading to better adhesion. However, this in turn leads to reduced water solubility of the binder.

U.S. Pat. No. 6,573,004 B1 describes copolymers of ethylene and vinyl alcohol as binders for electrode materials. The binder material has to have an appropriate number of vinyl alcohol units for a sufficient adhesion and cohesion. This gives rise to a corresponding molar mass, which affects the viscosity and/or elasticity and/or water solubility of the polymer. Only when viscosity, adhesion and elasticity are adjusted by means of various polymers can these properties be optimized independently in interplay with the optimal solubility.

EP1791199A1 describes a binary polymer system, wherein the polymers differ in terms of solubility/swellability in the electrolyte. This polymer system is applied in a two-stage process, and thus gives rise to a complex processing method.

EP2410597 A2 describes polymers (e.g. polyvinyl alcohols) having a cohesion of at least 100 gf/cm and an adhesion in the range from 0.1 to 70 gf/mm, which again entails the use of high molecular weight binders and hence restricts processing from aqueous solvents.

The invention provides a polymer composition P comprising 100 parts by weight of polymer 1 having a water solubility of at least 50 g/L at 25° C. and 1 bar, preparable by free-radically initiated polymerization of more than 95% by weight of one or more monomers from the group of acrylic acid or esters thereof or methacrylic acid or esters thereof, acrylonitrile and vinyl esters,

optionally followed by hydrolysis,
10 to 200 parts by weight of polymer 2 having a water solubility of at least 10 g/L at 25° C. and 1 bar,
having a viscosity of a 1% by weight aqueous solution at 25° C. and 1 bar of >1.0 Pas at a shear rate of 10/s, and of <0.7 Pas at a shear rate of 120/s,
from the group of the polysaccharides, celluloses or the carboxymethyl, methyl, hydroxyethyl or hydroxypropyl derivatives thereof, and
20 to 300 parts by weight of polymer 3 having a water solubility of at least 10 g/L at 25° C. and 1 bar, preparable by free-radically initiated polymerization of 30%-95% by weight of monomer A, from one or more monomers from the group of acrylic acid or esters thereof or methacrylic acid or esters thereof and vinyl esters and
5%-70% by weight of monomer B of the general formula R—CH═CH₂ where R is defined as hydrogen, methyl, ethyl, propyl, isopropyl, phenyl or o-tolyl,
optionally followed by hydrolysis.

The polymer composition P is of excellent suitability as an electrochemically stable binder system for electrode inks in lithium ion batteries. Use of polymer 2 as thickener adjusts or defines the rheological characteristics of the polymer composition P. A particular feature of the polymer composition P is ease of preparability, since commercially available standard polymers can be blended in a suitable ratio. Surprisingly, the ternary polymer composition P can also reduce the continuous irreversible loss of capacity (especially significant at high areal loadings) and the continuous irreversible loss of lithium in lithium ion batteries. A small irreversible loss of lithium is very important for high cycling stability of full cells.

The shear-thinning rheology of the polymer composition P leads to low viscosity on bar coating and homogenization, for example in a dissolver, with simultaneously high viscosity in the absence of shear. Therefore, it is possible to formulate sedimentation-stable and very homogeneous electrode inks with the polymer composition P even in the case of a very high solids content and low binder concentrations in the ink solution. Furthermore, it is then possible to obtain a very homogeneous coating. Known standard ink formulations based on PvOH or acrylates, by contrast, do not have shear-thinning rheology characteristics, but have newtonian rheology characteristics. In the ternary mixture of polymers 1-3, the adhesion and rheology can be adjusted with infinite variability over the mixing ratios and hence matched to the respective active material. The polymer composition P enables simple one-stage formulation of a sedimentation-stable electrode ink from aqueous solution, which can be processed directly by bar coating onto the electrode carrier (=current collector).

Lithium ion batteries wherein the electrode inks contain polymer composition P have high cycling stability even at high areal loadings. Standard binders, by contrast, exhibit high cycling stability only at low areal loadings in Si-containing systems.

In addition, the presence of polymer 3 improves the stability of the SEI and hence reduces the irreversible loss of lithium.

All components (polymer 1, polymer 2 and polymer 3) are water-soluble; the binder formulation for electrode inks can be processed from aqueous solution.

Preferably, at least 80 g/L, especially at least 120 g/L, of polymer 1 is water-soluble at 25° C. and 1 bar.

Preferred vinyl esters are vinyl acetate, vinyl propionate, vinyl butyrate, vinyl 2-ethylhexanoate, vinyl laurate, 1-methylvinyl acetate, vinyl pivalate, and vinyl esters of α-branched monocarboxylic acids having 9 to 11 carbon atoms, for example VeoVa9R or VeoVa10R (trade names of Shell). Particular preference is given to vinyl acetate. Preferred vinylaromatics are styrene, methylstyrene and vinyltoluene. A preferred vinyl halide is vinyl chloride. The preferred olefins are ethylene and propylene, and the preferred dienes are 1,3-butadiene and isoprene.

Suitable monomers from the group of the esters of acrylic acid or methacrylic acid are, for example, esters of unbranched or branched alcohols having 1 to 15 carbon atoms. Preferred methacrylic or acrylic esters are methyl acrylate, methyl methacrylate, ethyl acrylate, ethyl methacrylate, propyl acrylate, propyl methacrylate, n-butyl acrylate, n-butyl methacrylate, 2-ethylhexyl acrylate. Particular preference is given to methyl acrylate, methyl methacrylate, n-butyl acrylate and 2-ethylhexyl acrylate.

Polymer 1 is preferably preparable by polymerization of more than 98% by weight of one or more monomers from the group of acrylic acid or esters thereof or methacrylic acid or esters thereof, acrylonitrile and vinyl esters, especially from the monomers mentioned alone.

When polymer 1 also contains other monomer units, these are preferably selected from the monomers B for polymer 3.

The polymerization level of polymer 1 is preferably Pn=500-3000, more preferably Pn=600- 2000, especially Pn=800-1200.

A preferred polymer 1 is partly hydrolyzed polyvinyl acetate having a hydrolysis level of preferably 70 to 99 mol%, more preferably 75 to 95 mol%, especially 80 to 90 mol%.

Preferably, at least 20 g/L, especially at least 50 g/L, of polymer 2 is water-soluble at 25° C. and 1 bar.

Preferably, the viscosity of a 1% aqueous solution at 25° C. and 1 bar at a shear rate of 10/s is >1.5 Pas, and at a shear rate of 120/s<0.5 Pas.

The viscosity is preferably measured on an Anton Paar MCR 302 rheometer in a cone-plate system (cone diameter 25 mm).

A preferred polymer 2 is carboxymethylcellulose.

Preferably, the polymer composition P contains 20 to 100 parts by weight, especially 30 to 50 parts by weight, of polymer 2.

Preferably at least 20 g/L, especially at least 50 g/L, of polymer 3 is water-soluble at 25° C. and 1 bar.

Preferably, in polymer 3, the ratio is 30%-95% by weight of monomer A and 5%-70% by weight of monomer B.

A particularly preferred monomer A is vinyl acetate. A particularly preferred monomer B is ethylene.

The polymerization level of polymer 3 is preferably Pn=50-3000, more preferably Pn=100-2000, especially Pn=200-1000.

Polymer 3 may be unhydrolyzed or hydrolyzed. If polymer 3 is used in hydrolyzed form, the hydrolysis level is preferably 10 to 99 mol %, especially 20 to 80 mol %.

A preferred polymer 3 is a copolymer formed from ethylene units with partly or fully hydrolyzed or unhydrolyzed vinyl acetate or isopropenyl acetate. Particular preference is given to a copolymer formed from ethylene units with partly hydrolyzed or unhydrolyzed vinyl acetate, with an ethylene content of 5% by weight-70% by weight, and a hydrolysis level of 0%-99%.

Preferably, the polymer composition P contains 40 to 200 parts by weight, especially 70 to 150 parts by weight, of polymer 3.

The invention likewise provides an electrode coating, preferably for the anode, for a lithium ion battery comprising the polymer composition P. The polymer composition P serves as binder in the electrode coating.

In the production of the electrode coating, preferably, an electrode ink which is also called electrode paste is applied, preferably by bar coating, in a dry layer thickness of 2 μm to 500 μm, preferably of 10 μm to 300 μm, especially preferably 50-300 μm onto a current collector, for example copper foil. Other coating methods such as spin-coating, dip-coating, pointing or spraying can likewise be used. The coating of the copper foil with the electrode ink of the invention may be preceded by a treatment of the copper foil with a standard primer, for example based on polymer resins. The latter increases adhesion on the copper, but itself has virtually no electrochemical activity.

The electrode ink is preferably dried to constant weight. The drying temperature is guided by the materials used and the solvent used. It is preferably between 20° C. and 300° C., more preferably between 50° C. and 150° C.

The electrode coating and electrode ink comprise the polymer composition P and an active material.

The active material for the electrode coating and electrode ink preferably consists of elements which are selected from carbon, silicon, lithium, tin, titanium and oxygen, and compounds thereof.

In addition, further conductive materials, for example conductive black, carbon nanotubes (CNT) and metal powders, may be present.

Preferred active materials are silicon, silicon oxide, graphite, silicon-carbon composites, tin, lithium, aluminum, lithium titanium oxide and lithium silicide. Especially preferred are graphite and silicon, and silicon-carbon composites.

When silicon powder is used as active material, the primary particle size is preferably 1-500 nm, more preferably 50-200 nm.

The proportion of silicon in the active material is preferably 5%-90% by weight, more preferably 5%-25% by weight.

The proportion of graphite in the active material is preferably 10%-95% by weight, more preferably 40%-75% by weight.

The electrode ink and electrode coating may comprise still further additives which especially serve to adjust the wetting properties or to increase the conductivity, and also dispersants, fillers and pore formers.

The electrode ink preferably comprises water as solvent.

The proportion of polymer composition P based on the electrode coating or the dry weight of the electrode ink is preferably 1% by weight—50% by weight, more preferably 2% by weight—30% by weight, especially −15% by weight.

The material processing of the electrode ink can be effected, for example, with speedmixers, dissolvers, rotor-stator machines, high-energy mills, planetary kneaders, stirred ball mills, agitator plates or ultrasound equipment. The solids content in the electrode ink is 5% by weight—95% by weight, more preferably 10% by weight—50% by weight, especially 15% by weight—30% by weight.

The electrode ink is dried to constant weight. The drying temperature is guided by the materials used and the solvent used. It is preferably 20° C.-300° C., more preferably 50° C.-150° C.

Finally, the electrode coatings can be calendered in order to establish a defined porosity.

The electrode coating preferably has an initial retention capacity (=ratio of discharge capacity (delithiation) to charge capacity (lithiation)) of at least 70%, more preferably of at least 90%, and a specific charge/discharge capacity of >400 mAh/g, more preferably >600 mAh/g.

The capacity per unit area of the electrode coating is preferably >1.5 mAh/cm², more preferably >2 mAh/cm².

The invention likewise provides a lithium ion battery comprising cathode, anode, separator and electrolyte, wherein the anode comprises the polymer composition P.

The invention likewise provides for the use of the polymer composition P as binder system for the anode of a lithium ion battery.

Cathode materials used may, for example, be Li metal, for example as foil, and lithium compounds such as lithium cobalt oxide, lithium nickel oxide, lithium nickel cobalt oxide (doped and undoped), lithium manganese oxide (spinel), lithium nickel cobalt manganese oxides, lithium nickel manganese oxides, lithium iron phosphate, lithium cobalt phosphate, lithium manganese phosphate, lithium vanadium phosphate or lithium vanadium oxides.

The separator is, for example, a membrane permeable only to ions, as known in battery production. The separator separates the anode from the cathode.

The electrolyte comprises lithium salt as conductive salt and aprotic solvent.

Usable conductive salts are, for example, LiPF₆, LiBF₄, LiClO₄, LiAsF₆, LiB(C₂O₄)₂, LiBF₂(C₂O₄,LiSO₃CₓF₂ₓ₊₁, LiN(SO₂CₓF₂ₓ₊₁)₂ and LiC(SO₂CxF₂ₓ₊₁)₃, where x assumes integer values from 0 to 8, and mixtures thereof.

The electrolyte contains preferably 0.1 mol/L up to the solubility limit of the conductive salt, more preferably 0.2 mol/L-3 mol/L, especially 0.5 to 2 mol/L, of lithium-containing conductive salt.

The aprotic solvent is preferably selected from organic carbonates such as dimethyl carbonate, diethyl carbonate, ethyl methyl carbonate, ethylene carbonate, vinylene carbonate, propylene carbonate, butylene carbonate; cyclic and linear esters such as methyl acetate, ethyl acetate, butyl acetate, propyl propionate, ethyl butyrate, ethyl isobutyrate; cyclic and linear ethers such as 2-methyltetrahydrofuran, 1,2-diethoxymethane, THF, dioxane, 1,3-dioxolane, diisopropyl ether, diethylene glycol dimethyl ether; ketones such as cyclopentanone, diisopropyl ketone, methyl isobutyl ketone; lactones such as γ-butyrolactone; sulfolane, dimethyl sulfoxide, formamide, dimethylformamide, 3-methyl-1,3-oxazolidine-2-one, acetonitrile, organic carbonic esters and nitriles, and mixtures of these solvents. Particular preference is given to the above-described organic carbonates.

Preferably, the electrolyte also comprises a film former such as vinylene carbonate, fluoroethylene carbonate, vinyl ethylene carbonate or fluoroacetone, by means of which it is possible to achieve a significant improvement in the cycling stability of the anode. This is ascribed mainly to the formation of a solid electrolyte interphase on the surface of the active materials. The proportion of the film former in the electrolyte is preferably 0.1% by weight—20.0% by weight, more preferably 0.2% by weight—15.0% by weight, especially 0.5% by weight—10% by weight.

The electrolyte may, as described, for example, in DE 10027626 A, also comprise further additives such as organic isocyanates for lowering the water content, HF scavengers, redox shuttle additives, flame retardants such as phosphates or phosphonates, solubilizers for LiF, organic lithium salts and/or complex salts.

The lithium ion battery of the invention can be used in any of the standard forms, in wound, folded or stacked form.

All substances and materials utilized for production of the lithium ion battery of the invention, as described above, are known. The production of the parts of the battery of the invention and the combination thereof to give the battery of the invention are effected by the methods known in the field of battery production.

In the examples which follow, unless stated otherwise in each case, all figures of amount and percentage are based on weight, all pressures are 0.10 MPa (abs.) and all temperatures are 23° C.

The solvents used for the syntheses have been dried by standard methods and stored under a dry argon atmosphere.

The following materials have been purchased from commercial sources and used directly without further purification: silicon nanopowder (20-30 nm; Nanostructured & Amorphous Materials), KS6L-C graphite (Timcal), carbon nanotubes (Baytubes C70P; Bayer Material Science), polyvinyl alcohol M13/140 (Wacker Chemie AG—hydrolysis level 86-89 mol %, Pn=1000), ethylene vinyl alcohol (Exceval® 2117, Kuraray Europe GmbH), polyethylene-vinyl acetate dispersion LL6050 (=Vinnapas® LL 6050, WACKER Chemie AG), carboxymethylcellulose (Ashland 9H7F, Ashland Inc., viscosity of a 1% aqueous solution: shear rate η (10/s)=0.47 Pas; (120/s)=1.3 Pas).

In example 1, the production of electrodes with polyvinyl alcohol, ethylene vinyl alcohol and sodium carboxymethylcellulose as polymer composition P (inventive) is elucidated.

1.00 g of nanoscale silicon (20-30 nm, Nanostructured & Amorphous Materials, Inc.) and 0.60 g of conductive black (Timcal®, Super C65) were dispersed in 15.00 g of a 2.5% by weight solution of polyvinyl alcohol (M13/140, Wacker Chemie AG), ethylene vinyl alcohol (Exceval® 2117, Kuraray Europe GmbH) and sodium carboxymethylcellulose (Aqualon® 9H7F, Ashland Inc.) with a weight ratio of 2:2:1 (based on the solids contents) in water by means of a SpeedMixer (Hauschild & Co KG, DAC 400.1 V-DP) at a speed of 2500 rpm for 5 min and then by means of a dissolver (VMA-Getzmann, Dispermat® LC30) at a speed of rotation of 9 m/s for 15 min with cooling at 20° C. Addition of 7 g of water and 2.90 g of graphite (Timcal® SFG6) was then followed by mixing by means of the SpeedMixer at a speed of 2500 rpm for 5 min and by means of the dissolver at a speed of rotation of 8 m/s for 15 min. After degassing in the SpeedMixer, the dispersion was applied by means of a film-coating frame of gap width 0.20 mm (Erichsen, model 360) to a copper foil (Schlenk Metallfolien, SE-Cu58) of thickness 0.030 mm. The electrode coating thus produced was then dried at 80° C. and air pressure 1 bar for 60 min. The mean basis weight of the dry electrode coating was 2.52 mg/cm². To test the quality of the coating, a representative section of the electrode coating is scored with a cross-cut pattern. The coating is mechanically stable and adheres on the surface. No fragments are detachable by means of the pulling test with Scotch® tape.

### Example 2

### Relates to the Testing of Electrodes from Example 1

The electrochemical studies were conducted in a half-cell in a three-electrode arrangement (zero-current potential measurement). The electrode coating from example 1 was used as working electrode, lithium foil (Rockwood® Lithium, thickness 0.5 mm) as reference electrode and counterelectrode. A 6-ply nonwoven stack impregnated with 100 μl of electrolyte (Freudenberg Vliesstoffe, FS2226E) served as separator. The electrolyte used consisted of a 1 molar solution of lithium hexafluorophosphate in a 3:7 (v/v) mixture of ethylene carbonate and diethyl carbonate to which 2% by weight of vinylene carbonate have been added. The cell was built in a glovebox (<1 ppm H₂O, 0₂); the water content in the dry mass of all components used was below 20 ppm.

The electrochemical testing was conducted at 20° C. The potential limits used were 40 mV and 1.0 V vs. Li/Li+. The charging/lithiation of the electrode was effected by the cc/cv (constant current/constant voltage) method at constant current and, after attainment of the voltage limit, at constant voltage until the current went below 50 mA/g. The discharging/delithiation of the electrode was effected by the cc (constant current) method with constant current until attainment of the voltage limit. The specific current chosen was based on the weight of the electrode coating.

The electrode coating from example 1 has a reversible initial capacity of about 765 mAh/g and, after 70 charge/discharge cycles, still has about 92% of its original capacity. The cumulated irreversible capacity (=sum of all charge capacities (lithiation) minus sum of all discharge capacities (delithiation)) for 70 cycles is 245 mAh/g.

Example 3 relates to the production and electrochemical characterization of an electrode coating with polyvinyl alcohol, polyethylene-vinyl acetate dispersion and sodium carboxymethylcellulose as polymer composition P (inventive).

4.25 g of a 17.3% by weight silicon suspension in ethanol having a particle size of d50=180 nm and 0.59 g of conductive black (Timcal® Super C65) were dispersed in 21.00 g of a 2.5% by weight solution of polyvinyl alcohol (M13/140, Wacker Chemie AG), polyethylene-vinyl acetate dispersion (Vinnapas® LL6050, Wacker Chemie AG) and sodium carboxymethylcellulose (Aqualon® 9H7F, Ashland Inc.) with a weight ratio (based on the solids contents) of 2:2:1 in water by means of a SpeedMixer at a speed of 2500 rpm for 5 min and then by means of a dissolver at a speed of rotation of 9 m/s for 15 min with cooling at 20° C.

Addition of 2.83 g of graphite (Timcal® SFG6) was then followed by mixing by means of the SpeedMixer at a speed of 2500 rpm for 5 min and by means of the dissolver at a speed of rotation of 8 m/s for 15 min. After degassing in the SpeedMixer, the dispersion was applied by means of a film-coating frame of gap width 0.25 mm (Erichsen, model 360) to a copper foil (Schlenk Metallfolien, SE-Cu58) of thickness 0.030 mm. The electrode coating thus produced was then dried at 80° C. and air pressure 1 bar for 60 min. The mean basis weight of the dry electrode coating was 2.51 mg/cm².

The electrochemical testing was conducted at 20° C. The potential limits used were 40 mV and 1.0 V vs. Li/Li+. The charging/lithiation of the electrode was effected by the cc/cv (constant current/constant voltage) method at constant current and, after attainment of the voltage limit, at constant voltage until the current went below 50 mA/g. The discharging/delithiation of the electrode was effected by the cc (constant current) method with constant current until attainment of the voltage limit. The specific current chosen was based on the weight of the electrode coating.

The electrode coating from example 3 has a reversible initial capacity of about 485 mAh/g and, after 70 charge/discharge cycles, still has about 73% of its original capacity. The cumulated irreversible capacity for 70 cycles is 207 mAh/g (see table 2).

(Comparative) example 4 relates to the production and electrochemical characterization of an electrode coating with sodium carboxymethylcellulose as binder (noninventive).

4.65 g of a 17.3% by weight silicon suspension in ethanol having a particle size of d50=180 nm and 0.48 g of conductive black (Timcal® Super C65) were dispersed in 22.87 g of a 1.4% by weight solution of sodium carboxymethylcellulose (Daicel® Grade 1380) in water by means of a dissolver at a speed of rotation of 18 m/s for 45 min with cooling at 20° C. Addition of 2.40 g of graphite (Timcal® SFG6) was then followed by stirring at a speed of rotation of 13 m/s for 30 min. After degassing, the dispersion was applied by means of a film-coating frame of gap width 0.25 mm (Erichsen, model 360) to a copper foil (Schlenk Metallfolien, SE-Cu58) of thickness 0.030 mm. the electrode coating thus produced was then dried at 80° C. and air pressure 1 bar for 60 min. The mean basis weight of the dry electrode coating was 2.31 mg/cm².

The electrochemical testing was conducted at 20° C. The potential limits used were 40 mV and 1.0 V vs. Li/Li+. The charging/lithiation of the electrode was effected by the cc/cv (constant current/constant voltage) method at constant current and, after attainment of the voltage limit, at constant voltage until the current went below 50 mA/g. The discharging/delithiation of the electrode was effected by the cc (constant current) method with constant current until attainment of the voltage limit. The specific current chosen was based on the weight of the electrode coating.

The electrode coating from example 4 has a reversible initial capacity of about 730 mAh/g and, after 70 charge/discharge cycles, still has about 63% of its original capacity. The cumulated irreversible capacity for 70 cycles is 854 mAh/g (table 2).

(Comparative) example 5 relates to the production and electrochemical characterization of an electrode coating with polyvinyl alcohol and sodium carboxymethylcellulose as binder (noninventive).

1.00 g of nanoscale silicon (20-30 nm, Nanostructured & Amorphous Materials, Inc.) and 0.60 g of conductive black (Timcal® Super C65) were dispersed in 15.00 g of a 2.5% by weight solution of polyvinyl alcohol (M13/140, Wacker Chemie AG) and sodium carboxymethylcellulose (Aqualon® 9H7F, Ashland Inc.) with a weight ratio of 4:1 in water by means of a SpeedMixer at a speed of 2500 rpm for 5 min and then by means of a dissolver at a speed of rotation of 9 m/s for 15 min with cooling at 20° C. Addition of 7 g of water and 2.90 g of graphite (Timcal® SFG6) was then followed by mixing by means of the SpeedMixer at a speed of 2500 rpm for 5 min and by means of the dissolver at a speed of rotation of 8 m/s for 15 min. After degassing in the SpeedMixer, the dispersion was applied by means of a film-coating frame of gap width 0.20 mm (Erichsen, model 360) to a copper foil (Schlenk Metallfolien, SE-Cu58) of thickness 0.030 mm. The electrode coating thus produced was then dried at 80° C. and air pressure 1 bar for 60 min. The mean basis weight of the dry electrode coating was 2.70 mg/cm².

The electrochemical testing was conducted at 20° C. The potential limits used were 40 mV and 1.0 V vs. Li/Li+. The charging/lithiation of the electrode was effected by the cc/cv (constant current/constant voltage) method at constant current and, after attainment of the voltage limit, at constant voltage until the current went below 50 mA/g. The discharging/delithiation of the electrode was effected by the cc (constant current) method with constant current until attainment of the voltage limit. The specific current chosen was based on the weight of the electrode coating.

The electrode coating from example 5 has a reversible initial capacity of about 860 mAh/g and, after 70 charge/discharge cycles, still has about 58% of its original capacity. The cumulated irreversible capacity for 70 cycles is 885 mAh/g (table 2).

(Comparative) example 6 relates to the production and electrochemical characterization of an electrode coating with ethylene vinyl alcohol and sodium carboxymethylcellulose as binder (noninventive).

1.00 g of nanoscale silicon (20-30 nm, Nanostructured & Amorphous Materials, Inc.) and 0.60 g of conductive black (Timcal® Super C65) were dispersed in 15.00 g of a 2.5% by weight solution of ethylene vinyl alcohol (Exceval® 2117, Kuraray Europe GmbH) and sodium carboxymethylcellulose (Aqualon® 9H7F, Ashland Inc.) with a weight ratio of 4:1 in water by means of a SpeedMixer at a speed of 2500 rpm for 5 min and then by means of a dissolver at a speed of rotation of 9 m/s for 15 min with cooling at 20° C. Addition of 7 g of water and 2.90 g of graphite (Timcal® SFG6) was then followed by mixing by means of the SpeedMixer at a speed of 2500 rpm for 5 min and by means of the dissolver at a speed of rotation of 8 m/s for 15 min. After degassing in the SpeedMixer, the dispersion was applied by means of a film-coating frame of gap width 0.20 mm (Erichsen, model 360) to a copper foil (Schlenk Metallfolien, SE-Cu58) of thickness 0.030 mm. The electrode coating thus produced was then dried at 80° C. and air pressure 1 bar for 60 min. The mean basis weight of the dry electrode coating was 2.70 mg/cm².

The electrochemical testing was conducted at 20° C. The potential limits used were 40 mV and 1.0 V vs. Li/Li+. The charging/lithiation of the electrode was effected by the cc/cv (constant current/constant voltage) method at constant current and, after attainment of the voltage limit, at constant voltage until the current went below 50 mA/g. The discharging/delithiation of the electrode was effected by the cc (constant current) method with constant current until attainment of the voltage limit. The specific current chosen was based on the weight of the electrode coating.

The electrode coating from example 6 has a reversible initial capacity of about 820 mAh/g and, after 70 charge/discharge cycles, still has about 63% of its original capacity. The cumulated irreversible capacity for 70 cycles is 1022 mAh/g (table 2).

### Evaluation of Irreversible Loss of Capacity

Table 2 lists the cumulated irreversible capacity determined over 70 charge/discharge cycles, i.e. the sum total irreversible loss of capacity (=sum of all charge capacities (lithiation) minus sum of all discharge capacities delithiation)) of the electrode coatings from examples 1, 3 and (comparative) examples 4-6.

The electrode coatings comprising the polymer composition P from examples 1 and 3 are notable for a smaller irreversible loss of capacity compared to the coatings from examples 4-6. This shows that, given a comparable composition of the electrode material, the use of the polymer composition P leads to an unexpected technical effect.

TABLE 2
Irreversible capacity cumulated over 70 cycles
polyvinyl alcohol = PVOH, ethylene vinyl alcohol = EVOH
sodium carboxymethylcellulose = NaCMC

| | | Reversible | Capacity | Irreversible |
|---|---|---|---|---|
| | | initial | retention | capacity |
| | | capacity | after 70 | cumulated over |
| Material | Binder | [mAh/g] | cycles [%] | 70 cycles |
| Ex. 1 | PVOH/EVOH/ | 765 | 92 | 245 mAh/g |
| | NaCMC | | | |
| Ex. 3 | PVOH/PVAC/ | 485 | 73 | 207 mAh/g |
| | NaCMC | | | |
| Ex. 4* | NaCMC | 730 | 63 | 854 mAh/g |
| Ex. 5* | PVOH/NaCMC | 860 | 58 | 885 mAh/g |
| Ex. 6* | EVOH/NaCMC | 820 | 63 | 1022 mAh/g |

*noninventive

### (Comparative) Example 7

### Processing Conditions without Polymer Composition P (Noninventive)

1.00 g of nanoscale silicon (20-30 nm, Nanostructured & Amorphous Materials, Inc.) and 0.60 g of conductive black (Timcal® Super C65) were dispersed in 15.00 g of a 2.5% by weight solution of polyvinyl alcohol (M13/140, Wacker Chemie AG) in water by means of a SpeedMixer (Hauschild & Co KG, DAC 400.1 V-DP) at a speed of 2500 rpm for 5 min and then by means of a dissolver (VMA-Getzmann, Dispermat® LC30) at a speed of rotation of 9 m/s for 15 min with cooling at 20° C. Addition of 2.90 g of graphite (Timcal® SFG6) was then followed by mixing by means of the SpeedMixer at a speed of 2500 rpm for 5 min and by means of the dissolver at a speed of rotation of 8 m/s for 15 min. After degassing in the SpeedMixer, the dispersion was applied by means of a film-coating frame of gap width 0.20 mm (Erichsen, model 360) to a copper foil (Schlenk Metallfolien, SE-Cu58) of thickness 0.030 mm. The electrode coating thus produced was then dried at 80° C. and air pressure 1 bar for 60 min. The mean basis weight of the dry electrode coating was 2.52 mg/cm².

To test the quality of the coating, a representative section of the electrode coating is scored with a cross-cut pattern. The coating is mechanically unstable. Fragments flake away from the coating. Further fragments are detachable by means of Scotch® adhesive tape.

Examples 1-6 exhibit a more homogeneous and stable coating compared to comparative example 7. Comparative example 7 is unsuitable as electrode for lack of mechanical stability and lack of homogeneity of the active materials (sedimentation of active material during the drying operation).

1. A polymer composition P comprising
100 parts by weight of polymer 1 having a water solubility of at least 50 g/L at 25° C. and 1 bar, wherein said polymer 1 is preparable by free-radically initiated polymerization of more than 95% by weight of one or more monomers selected from the group consisting of acrylic acid esters of acrylic acid, methacrylic acid esters of methacrylic acid, acrylonitrile and vinyl esters, optionally followed by hydrolysis,
10 to 200 parts by weight of polymer 2 having a water solubility of at least 10 g/L at 25° C. and 1 bar, having a viscosity of a 1% by weight aqueous solution at 25° C. and 1 bar of >1.0 Pas at a shear rate of 10/s, and of <0.7 Pas at a shear rate of 120/s, wherein said polymer 2 is a member selected from the group consisting of polysaccharides, celluloses, carboxymethyl, methyl, hydroxyethyl and hydroxypropyl derivatives thereof, and
20 to 300 parts by weight of polymer 3 having a water solubility of at least 10 g/L at 25° C. and 1 bar, preparable by free-radically initiated polymerization of 30%-95% by weight of monomer A, which is at least one member selected from the group consisting of acrylic acid esters of acrylic acid, methacrylic acid, esters of methacrylic acid and vinyl esters, and 5%-70% by weight of monomer B of the general formula R—CH═CH₂ where R is defined as hydrogen, methyl, ethyl, propyl, isopropyl, phenyl or o-tolyl, optionally followed by hydrolysis.

2. The polymer composition P as claimed in claim 1, in which polymer 1 has a polymerization level Pn=600-2000.

3. The polymer composition P as claimed in claim 1, in which polymer 1 is partly hydrolyzed polyvinyl acetate having a hydrolysis level of 75-95 mol %.

4. The polymer composition P as claimed in claim 1, in which polymer 2 is carboxymethyl-cellulose.

5. The polymer composition P as claimed in claim 1, in which monomer A of polymer 3 is vinyl acetate.

6. The polymer composition P as claimed in claim 1, in which monomer B of polymer 3 is ethylene.

7. The polymer composition P as claimed in claim 1, in which polymer 3 has been hydrolyzed and the hydrolysis level is 10 to 99 mol %.

8. An electrode coating for a lithium ion battery, comprising the polymer composition P as claimed in claim 1, wherein a total binder content is 1%-50% by weight.

9. The electrode coating as claimed in claim 8, comprising a silicon-containing active anode material.

10. A lithium ion battery comprising a cathode, an anode, a separator and an electrolyte, wherein the anode comprises the polymer composition P as claimed in claim 1.

11. The composition P as claimed in claim 1, which is a binder system for an anode of a lithium ion battery.

12. The polymer composition P as claimed in claim 2, in which polymer 1 is partly hydrolyzed polyvinyl acetate having a hydrolysis level of 75-95 mol %.

13. The polymer composition P as claimed in claim 12, in which polymer 2 is carboxymethyl-cellulose.

14. The polymer composition P as claimed in claim 13, in which monomer A of polymer 3 is vinyl acetate.

15. The polymer composition P as claimed in claim 14, in which monomer B of polymer 3 is ethylene.

16. The polymer composition P as claimed in claim 15, in which polymer 3 has been hydrolyzed and the hydrolysis level is 10 to 99 mol %.

17. An electrode coating for a lithium ion battery, comprising the polymer composition P as claimed in claim 16, wherein a total binder content is 1%-50% by weight.

18. The electrode coating as claimed in claim 17, comprising a silicon-containing active anode material.

19. A lithium ion battery comprising a cathode, an anode, a separator and an electrolyte, wherein the anode comprises the polymer composition P as claimed in claim 16.

20. The polymer composition P as claimed in claim 16, which is a binder system for an anode of a lithium ion battery.
